(19) United States
(12) Patent Application Publication
(10) Pub. No.: US 2013/0195454 A1
(43) Pub. Date: Aug. 1, 2013

(54) WAVELENGTH MULTI-CASTING METHOD IN MULTI-RING NETWORK, MULTI-RING NETWORK DEVICE, AND MULTI-RING NETWORK NODE

(71) Applicant: Hyun Jae LEE, Daejeon (KR)

(72) Inventor: Hyun Jae LEE, Daejeon (KR)

(73) Assignee: Electronics and Telecommunications Research Institute, Daejeon (KR)

(21) Appl. No.: 13/617,622

(22) Filed: Sep. 14, 2012

(30) Foreign Application Priority Data
Jan. 28, 2012 (KR) 10-2012-0008644

(51) Int. Cl. H04B 10/20

(52) U.S. Cl. 398/59

(57) ABSTRACT

Disclosed are a wavelength multi-casting method and device in a multi-ring network, and more particularly, a wavelength multi-casting method and device in a multi-ring network capable of configuring an economical network. The wavelength multi-casting method in the multi-ring network according to the exemplary embodiment of the present invention includes: receiving, by one node, optical signals from other nodes within a ring network to which the node belongs; and multi-casting, by the node, an optical wavelength to neighboring nodes by a scheme of dropping and continuing the transmitted optical signals.

### CROSS-REFERENCE TO RELATED APPLICATIONS

This application claims priority to and the benefit of Korean Patent Application No. 10-2012-0008644 filed in the Korean Intellectual Property Office on Jan. 28, 2012, the entire contents of which are incorporated herein by reference.

### TECHNICAL FIELD

The present invention relates to a wavelength multi-casting method and device in a multi-ring network, and more particularly, a wavelength multi-casting method in a multi-ring network capable of configuring an economical network, a multi-ring network device, and a multi-ring network node.

### BACKGROUND ART

Generally, a ring network system includes a plurality of node devices sequentially connected with each other through a transmission medium having a ring form. In the ring network node according to the related art, signals are separated by a method of dropping and continuing signals and processed by a receiving unit, and required signals are again retransmitted by a transmitter.

FIG. 1 shows a method of adding/dropping signals in the single ring network according to the related art.

Referring to FIG. 1, in the single ring network node according to the related art, when n optical channels are dropped from No. 2 node by the method of adding/dropping signals, n signals may be added. The signals are continued through other channels other than the dropping channels and transmitted to No. 3 node. Among the added and continued signals, m optical channels are dropped and m optical channels are added, at No. 3 node. When using a controllable wavelength control transmitter, it is possible to implement more flexible addition/drop.

The ring network system according to the related art processes signals using receivers and transmitters for each channel and therefore, has a complicated structure and is not economical.

### SUMMARY OF THE INVENTION

The present invention has been made in an effort to provide a wavelength multi-casting method in a multi-ring network capable of configuring a simple and economical network, a multi-ring network device, and a multi-ring network node.

An exemplary embodiment of the present invention provides a wavelength multi-casting method in a multi-ring network, including: multicasting by one node, and optical wavelength to neighboring nodes by a scheme of dropping and continuing optical signals transmitted from other nodes within a ring network to which the node belongs; and multi-casting, by the neighboring node, an optical wavelength by a scheme of dropping and continuing the optical signals transmitted from other nodes within the ring network to which the node belongs.

Another exemplary embodiment of the present invention provides a multi-ring network device, including: a plurality of nodes including an optical signal channel drop and continue module; and an optical fiber provided between the nodes, wherein the optical signal drop and continue module drops and continues optical signals returned from other nodes within a ring network to which the corresponding nodes belong and neighbor ring networks of the ring network.

Yet another exemplary embodiment of the present invention provides a multi-ring network node, including: an optical signal drop and continue module that drops and continues optical signals returned from other nodes within a ring network to which the node belongs and neighboring ring networks of the ring network; an optical coupler and an optical separator that drop and add the optical signals and transmit the dropped and added optical signals to other nodes within the ring network to which the node belongs and the neighboring ring networks of the ring network; and a band cutoff filter that separates the optical signals of the node transmitted to the neighboring nodes within the multi-ring network to which the node belongs and then, returned thereto by using a band cutoff filter.

According to the exemplary embodiment of the present invention, the signals are separated using the simple optical separator/coupler, thereby implementing the wavelength multi-casting at the multi-ring network node.

The wavelength multi-casting method can be effectively configured at the multi-ring network node without using the expensive optical device, thereby saving Capex and Opex, configuring the economical network, and implementing the multi-ring network node to which various wavelength multi-casting schemes are applied.

The overall signals transmitted from other nodes can be dropped by the optical separator at the dropping node, the dropped optical signals can be separated for each band or each wavelength using the optical separator, and the separated signals are subjected to optical/electrical conversion to perform the signal processing. The dropped optical signals can be processed by separating the signals using the band filter. Only the coupled signals are subjected to the electrical/optical conversion at the time of the signal addition to add the optical signals and therefore, the remaining signals pass in the optical signal form as they are without the electrical/optical conversion, thereby providing the optical wavelength multi-casting function having the simple system.

When using the wavelength multi-casting method in the multi-ring network node according to the exemplary embodiment of the present invention, a variety of information served from the single ring network for each area can be conveniently used even in the single ring network of other areas.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows a method of adding/dropping signals in a single ring network according to the related art.

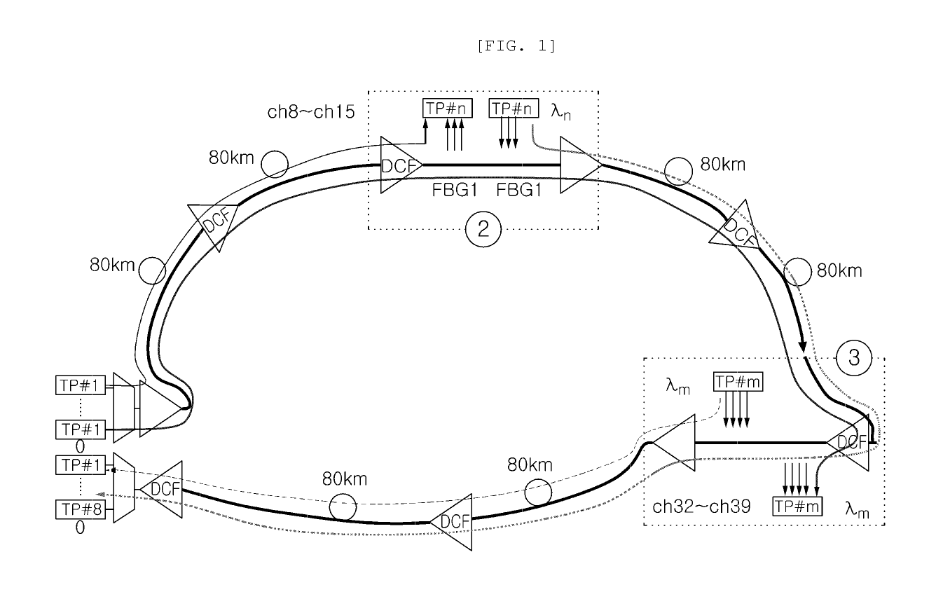

FIG. 2 is a diagram showing a wavelength multi-casting method at each node of a single network according to an exemplary embodiment of the present invention.

FIG. 3 is a diagram showing a wavelength multi-casting method at two ring networks according to the exemplary embodiment of the present invention.

FIG. 4 is a diagram showing a wavelength multi-casting method at three ring networks according to the exemplary embodiment of the present invention.

FIG. 5 is a diagram showing a wavelength multi-casting method at four ring networks according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a wavelength multi-casting method in a multi-ring network, a multi-ring network device, and a multi-ring network node according to exemplary embodiments of the present invention will be described with reference to the accompanying drawings.

The present invention relates to a wavelength multi-casting method in a multi-ring network, a multi-ring network device, and a multi-ring network node. A method of dropping/continuing a wavelength at a single ring network node required to drop a wavelength is applied to the optical signals transmitted from the multi-ring network to continuously pass the dropped optical signals to neighboring nodes and transmit the optical signals to other nodes through the neighboring nodes. When using the exemplary embodiment of the present invention, it is possible to multi-cast the optical signals by transmitting signals transmitted from a single ring network to nodes of other several ring networks.

When using the wavelength multi-casting method at the multi-ring network node according to the exemplary embodiment of the present invention, the number of channels received from other ring networks can be the entire number of channels transmitted through the optical fiber. If necessary, it is possible to perform signal processing by selecting signals of all the channels for each channel and each band. The number of additionally required channels can be transmitted to other nodes using a separate transmitter without using the transmitters for the entire number of dropped channels, thereby configuring a network capable of saving Capex and Opex costs. The number of input channels added to an optical amplifier is the same by cutting-off the signals transmitted by the node itself behind the node by adding the cutoff filter thereinto, thereby conveniently controlling the amplifier.

In the multi-ring network according to the exemplary embodiment of the present invention, the wavelength multi-casting method and the multi-ring network device will be described below in more detail.

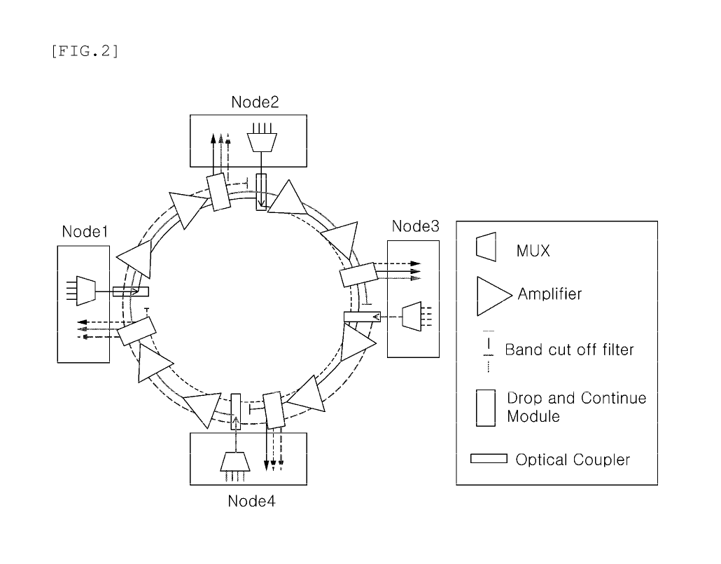

FIG. 2 is a diagram showing a wavelength multi-casting method at each node of a single ring network according to the exemplary embodiment of the present invention.

Referring to FIG. 2, each node of a ring network system is provided with a channel drop and continue module, a multiplexer (MUX), an optical coupler, and a band cutoff filter and an optical amplifier is provided between nodes.

As can be appreciated from FIG. 2, the signals are dropped/continued by using the drop and continue module that can drop/continue the signals transmitted from other nodes to drop/continue the signals at each node and the continued signals are transmitted to neighboring nodes. Even in the neighboring nodes, the signals transmitted from other nodes are dropped/continued using the channel drop/continue module. As the channel separating method, there are a method for separating all the signals, a separating method for each band, a separating method each channel, and the like. When configuring a network by the foregoing structure, it is possible to effectively operate the optical channels.

When applying the multi-casting method, the signals transmitted from all the other nodes can be transmitted via the channel drop and continue module. That is, various optical signals transmitted from each node can use the optical coupler for each channel, each band, and each signal and can be transmitted to other nodes.

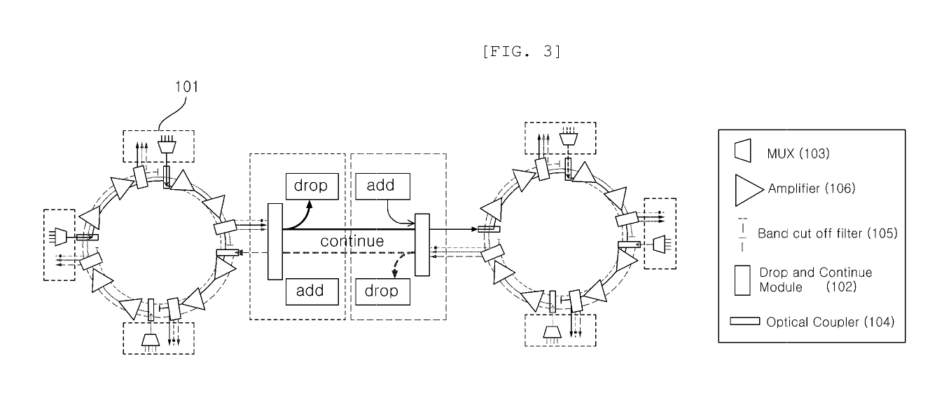

FIG. 3 is a diagram showing a wavelength multi-casting method at two ring networks according to the exemplary embodiment of the present invention. For convenience of explanation in FIG. 3, the signals returned from a left ring network are shown by the thickest solid line and the signals returned from a right ring network are shown by the thickest dotted line, by coupling the signals returned from other three networks of the single ring network, respectively. In this case, the wavelengths included in the thickest solid line and the wavelengths included in the thickest dotted line may be controlled so as not to overlap each other.

Referring to FIG. 3, each node 101 of each ring network system is provided with a channel drop and continued module 102, a multiplexer (MUX) 103, an optical coupler 104, and a band cutoff filter 105 and an optical amplifier 106 is provided between nodes 101. Here, the nodes used for exchanging signals with another ring network among nodes drop and add the optical signals using the optical coupler and the optical separator and couple them.

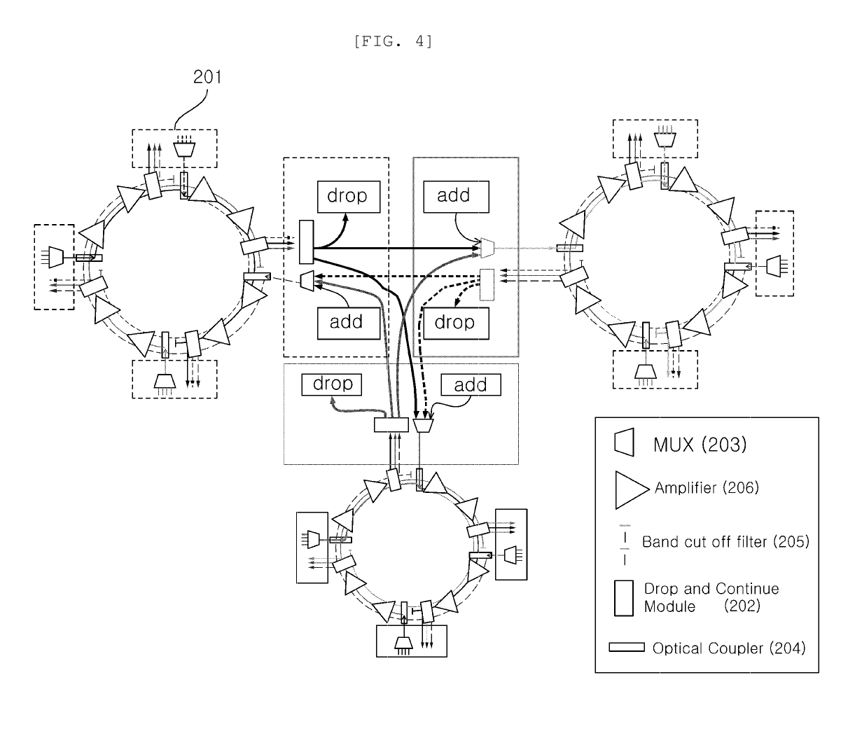

FIG. 4 is a diagram showing a wavelength multi-casting method at three ring networks according to the exemplary embodiment of the present invention. For convenience of explanation in FIG. 4, the signals transmitted from a left ring network are shown by the thickest black solid line, the signals transmitted from a right ring network are shown by the thickest black dotted line, and the signals transmitted from the bottom ring network are shown by the thickest soft solid line, by coupling the signals transmitted from other three networks of the single ring network, respectively. In this case, the wavelengths included in the thickest solid line, the wavelengths included in the thickest dotted line, and the thickest soft solid line can be controlled so as not to overlap one another.

Referring to FIG. 4, each node 201 of each ring network system is provided with a channel drop and continued module 202, a multiplexer (MUX) 203, an optical coupler 204, and a band cutoff filter 205 and an optical amplifier 206 is provided between nodes 101. Here, the nodes used for exchanging signals with another ring network among nodes drop and add the optical signals using the optical coupler and the optical separator and couple the dropped and added signals.

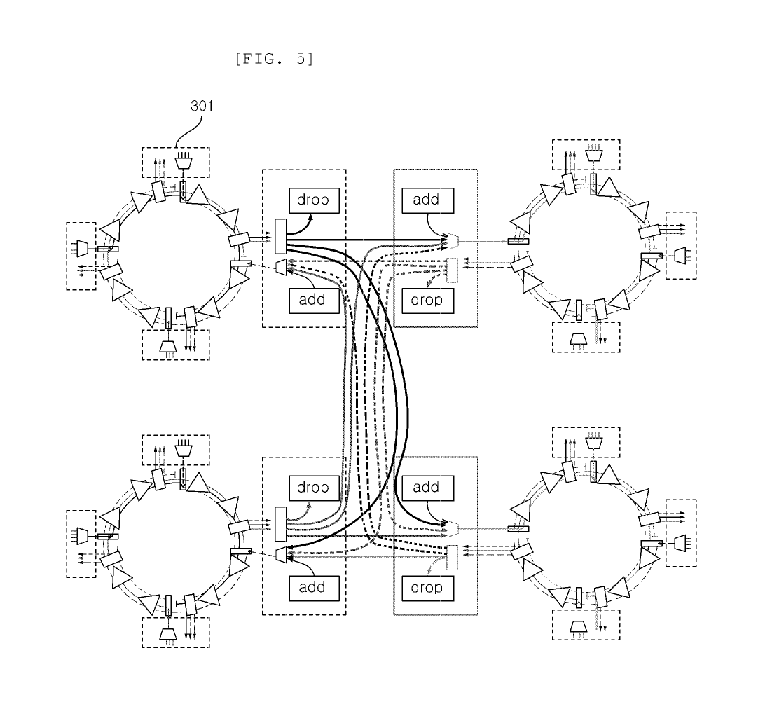

FIG. 5 is a diagram showing a wavelength multi-casting method at four ring networks according to the exemplary embodiment of the present invention. For convenience of explanation in FIG. 5, the signals transmitted from the ring network of the upper left are shown by the thickest black dotted line, the signals transmitted from the ring network of the upper right are shown by the thickest soft dotted line, the signals transmitted from the ring network of the bottom left are shown by the thickest soft solid line, and the signals transmitted from the ring network of the bottom right are shown by the thickest black dotted line, by coupling the signals transmitted from other three nodes, respectively. In this case, the wavelengths included in the thickest black dotted line, the wavelengths included in the thickest soft dotted line, the wavelengths included in the thickest soft solid line, the wavelengths included in the thickest soft solid line, and the wavelengths included in the thickest black dotted line may be controlled so as not to overlap one another.

Referring to FIG. 5, each node 203 of each ring network system is provided with the channel drop and continued module 202, the multiplexer (MUX) 203, the optical coupler 204, and the band cutoff filter 205 and the optical amplifier 206 is provided between the nodes 101. Here, the nodes used for exchanging signals with another ring network among nodes drop and add the optical signals using the optical coupler and the optical separator and couple the dropped and added signals.

Referring to FIGS. 3 to 5, the optical signals transmitted from other ring networks and the optical signals added in the single ring network can be extracted from each ring network and the added signals can be separated and output for each band or channel or for the overall signals. When configuring a network by the foregoing structure, it is possible to effectively operate the optical channels.

The signals transmitted to the neighboring nodes and then, returned thereto again are separated by using the band cutoff filter, thereby preventing the optical signal channels transmitted from the node from interfering with each other. In this case, it is possible to cutoff any channel or band or the overall channels, if necessary.

When adding the signals, the multiplexer and the optical coupler can couple several channels so as to be transmitted to the optical fiber. Since the number of optical wavelengths input to the optical amplifier from the node of the ring network is the same, it is possible to easily control the amplifier.

The optical amplifier used in the exemplary embodiment of the present invention is usefully used to compensate for the reduced optical signals at the time of the drop/continue of the optical signal channels and the channel coupling and compensate for the reduced signals at the long distance transmission. By using the method, the signals can be usefully used to broadcast signals.

When the wavelength multi-casting method is applied at the nodes of the multi-ring network according to the exemplary embodiment of the present invention, the signals transmitted from all the other ring networks can be extracted via the drop and continue module from the nodes of the ring network and transmit the extracted signals. Each node at the single ring network can transmit the optical signals wanted to be transmitted to the nodes in the same single ring and other ring networks by using the optical separator and the optical coupler. The number of input channels added to the optical amplifier is the same by cutting off the signals transmitted by the node itself behind the node of the network by adding the cutoff filter thereinto, thereby conveniently controlling the amplifier.

According to the exemplary embodiment of the present invention, the signals are separated using the simple optical separator/coupler, thereby implementing the wavelength multi-casting at the multi-ring network node.

The wavelength multi-casting method can be effectively configured at the multi-ring network node without using the expensive optical device, thereby saving Capex and Opex, configuring the economical network, and implementing the multi-ring network node to which various wavelength multi-casting schemes are applied.

The overall signals transmitted from other nodes can be dropped by the optical separator at the dropping node, the dropped optical signals can be separated for each band or each wavelength using the optical separator, and the separated signals are subjected to optical/electrical conversion to perform the signal processing. The extracted optical signals can be processed by separating the signals using the band filter. Only the coupled signals are subjected to the electrical/optical conversion at the time of the signal addition to add the optical signals and therefore, the remaining signals pass in the optical signal form as they are without the electrical/optical conversion, thereby providing the optical wavelength multi-casting function having the simple system.

When using the wavelength multi-casting method in the multi-ring network node according to the exemplary embodiment of the present invention, a variety of information served from the single ring networks for each area can be conveniently used even in the single ring network of other areas.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A wavelength multi-casting method in a multi-ring network, comprising:
receiving, by one node, optical signals from other nodes within a ring network to which the node belongs; and
multi-casting, by the node, an optical wavelength to neighboring nodes by a scheme of dropping and continuing the transmitted optical signals.

2. The method of claim 1, wherein the node separates its own optical signals transmitted to the neighboring nodes and then, returned thereto by using a band cutoff filter.

3. The method of claim 1, wherein the node compensates for the optical signals reduced during drop, continue, and transmission processes by an amplifier.

4. The method of claim 1, wherein the node multicasts an optical wavelength by a scheme of dropping and continuing the optical signals transmitted from neighbor ring networks of the ring network to which the node belongs.

5. The method of claim 1, wherein the node drops and adds the optical signals using an optical coupler and an optical separator.

6. A multi-ring network device, comprising:
a plurality of nodes including an optical signal drop and continue module; and
an optical fiber provided between the nodes,
wherein the optical signal drop and continue module drops and continues optical signals returned from other nodes within a ring network to which the corresponding nodes belong and neighbor ring networks of the ring network.

7. The device of claim 6, wherein the node includes a band cutoff filter that separates its own optical signals transmitted to the neighboring nodes and then, returned thereto.

8. The device of claim 6, wherein an amplifier amplifying the optical signals reduced during drop, continue processes of the optical signals is provided between the nodes.

9. The device of claim 6, wherein the node includes an optical coupler and an optical separator for dropping and adding the optical signals.

10. A multi-ring network node, comprising:
an optical signal drop and continue module that drops and continues optical signals returned from other nodes within a ring network to which the node belongs and neighboring ring networks of the ring network;
an optical coupler and an optical separator that drop and add the optical signals and transmit the dropped and added optical signals to other nodes within the ring network to which the node belongs and the neighboring ring networks of the ring network; and
a band cutoff filter that separates the optical signals of the node transmitted to the neighboring nodes within the multi-ring network to which the node belongs and then, returned thereto.
